(19) United States
(12) Patent Application Publication
(10) Pub. No.: US 2006/0157534 A1
(43) Pub. Date: Jul. 20, 2006

(54) Components with solder masks

(75) Inventor: Masud Beroz, Cary, NC (US)

Correspondence Address: TESSERA;LERNER DAVID et al., 600 SOUTH AVENUE WEST, WESTFIELD, NJ, 07090, US

(73) Assignee: Tessera, Inc., San Jose, CA (US)

(21) Appl. No.: 11/195,438

(22) Filed: Aug. 2, 2005

Related U.S. Application Data
(60) Provisional application No. 60/599,491, filed on Aug. 6, 2004.

(51) Int. Cl. B23K 1/08; B23K 37/06

(52) U.S. Cl. 228/39

(57) ABSTRACT

In a surface mounting operation for connecting a semiconductor chip and connection component, at least one of the chip or the component has a plurality of elongated pads having a length being greater than the width. The elongated pads are preferably parallel to each other on the chip or component. A solder mask layer may be placed over a selected number of the pads before a bonding operation. The solder mask layer preferably has elongated apertures which are arranged in a perpendicular fashion to the elongated pads. A slight misalignment of the solder mask will not affect the surface area of the pad that shows through the elongated apertures of the solder mask.

### CROSS-REFERENCE TO RELATED APPLICATIONS

This application claims the benefit of the filing date of U.S. Provisional Patent Application No. 60/599,491 filed Aug. 6, 2004, the disclosure of which is hereby incorporated herein by reference.

### FIELD OF THE INVENTION

The present invention relates to microelectronic components and to assembly of such components.

### BACKGROUND OF THE INVENTION

Microelectronic elements such as semiconductor chips and small circuit panels commonly are connected to one another by a process referred to as “surface-mounting.” In a typical surface-mounting operation, each component has a body with front surface and electrically conductive elements referred to as “pads” exposed at such surface. The pads are formed from metallic materials which are wettable by molten solder. Solder is provided on the pads of one of the components. The component bodies are positioned with their front surfaces facing one another, so that the pads on the two components confront one another. The assembly is heated to melt or “reflow” the solder, so that the molten solder wets the pads on both components. When the assembly is cooled, the solder forms metallic, electrically-conductive joints between the pads.

A component for use in a surface-mounting operation may be provided with a layer commonly referred to as a “solder mask” covering the front surface of the body. Such a layer is formed from a polymeric material or other material which is not wettable by the solder, and has apertures aligned with the pads. The solder mask layer helps to confine the molten solder during the reflow operation. For example, the body may include traces extending along the front surface in the vicinity of the pads. The solder mask layer prevents the solder from wetting these traces and spreading along the traces during reflow. The solder mask layer also keeps the solder from flowing or “bridging” between adjacent pads.

Misalignment of the apertures in the solder mask and the pads can cause variation in the amount of pad area available for wetting by the solder. In a “pad defined” configuration, the aperture in the solder mask is larger than the pad. When the pad and aperture are properly aligned, the entire pad is exposed through the aperture. However, if the aperture is off-center with respect to the pad, a portion of the pad is covered by the mask. In a “mask defined” configuration, the pad is larger than the aperture. When the pad and mask are properly aligned, the entire aperture overlies the pad, so that an area of the pad equal to full area of the aperture is exposed. If the aperture is off-center with respect to the pad, only a portion of the aperture overlies the pad, so that the area of the pad exposed for wetting by the solder is equal to the area of only this portion.

Variations in the pad area available for wetting can cause variations in the amount of solder which will adhere to the pad. For example, when solder is applied to the pads to form solder masses prior to assembly, the solder masses adhering to different pads will contain different volumes of solder. This, in turn, can cause difficulties in testing the component prior to assembly and difficulties in forming reliable solder joints. These problems are particularly significant in the case of components having small pads, such as semiconductor chips.

### SUMMARY OF THE INVENTION

In one aspect of the invention, a component is provided comprising a body which may be a semiconductor chip or connection component, having a front surface and a plurality of elongated solder-wettable pads exposed at said front surface. Each of the pads preferably has lengthwise and widthwise directions and pad length and pad width dimensions. A solder mask layer may be provided which overlies at least a part of the front surface of the body. The solder mask layer preferably has a plurality of elongated apertures, each having long and short dimensions. At least some of the apertures preferably extend across at least some of said pads so as to form a plurality of units. Each unit includes one of the pads and one of the apertures extending across the pad in such unit. The long dimension of the aperture in each such unit extends in the widthwise direction of the pad. The long dimension of the aperture is greater than the width of the pad so that the aperture extends beyond the pad on two opposite sides thereof. The pad length of the pad in each such unit is preferably greater than the short dimension of the aperture in such unit so that the pad extends beyond the aperture on two opposite sides thereof. Each such unit preferably has a wettable area having dimensions equal to the width of the pad and the short dimension of the aperture. This, in preferred structures according to this aspect of the invention, minor displacement of the solder mask layer with respect to the body will not affect the size or shape of the wettable areas.

The pad widths of all of the pads may be substantially equal and the short dimensions of all of the apertures may be substantially equal, which makes the dimensions of all of said wettable areas substantially equal. The lengthwise directions of all of the pads may be parallel to one another.

In another aspect of the invention, the body may have traces extending along said front surface between at least some of said pads, said traces extending predominantly in a direction parallel to the lengthwise directions of said pad.

The component may further comprise masses of solder adhering to the wettable areas of the units.

Another aspect of the invention provides methods of making a microelectronic assembly. A method according to this aspect of the invention desirably includes placing a component as described above over a substrate so that said units confront lands on said substrate, providing solder between said units and said lands, and solder bonding the wettable areas of said units to the lands. The solder may be provided on the wettable areas of the units before the component is placed over the substrate.

A further aspect of the invention provides methods of making a microelectronic component. A method according to this aspect desirably comprises the steps of providing a body having a front surface and elongated solder-wettable pads and providing a solder mask over at least a portion of the front surface so that elongated apertures in the solder mask extend across the elongated pads to form units. The aperture of each unit preferably extends beyond the pad of the unit on two opposite sides thereof. The pad of each unit desirably extends beyond the aperture of the unit on two opposite sides thereof. Thus, each unit has a wettable area with dimensions equal to the short dimension of the aperture and the widthwise dimension of the pad. The solder mask may be selectively exposed to light so as to form the apertures. The solder mask may also be formed with the apertures and laminated on the front surface of the body.

### BRIEF DESCRIPTION OF THE DRAWINGS

FIG. 1 is a diagrammatic top plan view of a body included in one embodiment of the invention.

FIG. 2 is a diagrammatic top plan view of a component including the body of FIG. 1.

FIG. 3 is a detail view on an enlarged scale of a portion of the component shown in FIG. 2.

FIGS. 4 and 5 are views similar to FIG. 3, but depicting the component in different tolerance conditions.

FIG. 6 is a diagrammatic elevational view of the component of FIG. 2, together with additional elements.

### DETAILED DESCRIPTION

A component in accordance with one embodiment of the present invention includes a body 10 having a front surface 12 with pads 14 exposed at the front surface. The pads 14 may be flush with the surrounding portions of the top surface, may protrude vertically from the surrounding portions, or may be recessed relative to the surrounding portions. Each contact 14 is elongated, and hence has a lengthwise direction Lp and a widthwise direction Wp, the dimension of the pad in the lengthwise direction being greater than the dimension of the pad in the widthwise direction. Each pad also has a pair of opposite long edges 16 extending in the lengthwise direction and spaced apart from one another in the widthwise direction. In the embodiment illustrated, the lengthwise directions of all of the pads are parallel to one another.

The pads are solder-wettable. That is, the exposed surfaces of the pads are formed from a material such as copper or gold which is capable of being wetted by a molten solder. Although wettability may vary with particular solder compositions, a surface which is wettable by a common lead/tin solder when such surface is clean and free of oxides can be considered as a solder-wettable surface. Those portions of front surface 12 which immediately surround pads 14 are not solder-wettable. In the particular embodiment illustrated, body 10 is a semiconductor chip and the portions of front surface 12 surrounding pads 14 are formed from a dielectric material, commonly referred to as a passivation layer, which overlies the active semiconductor elements of the chip. The passivation layer may include inorganic dielectrics such as silicon oxides and silicon nitrides, and may also include polymeric dielectrics such as polyimides. In other embodiments, body 10 may be a dielectric element adapted for use as a connection component for mounting semiconductor chips to circuit boards, or may be a portion of a circuit board. In these cases, the front surface of body 12 typically is formed from an organic or inorganic dielectric.

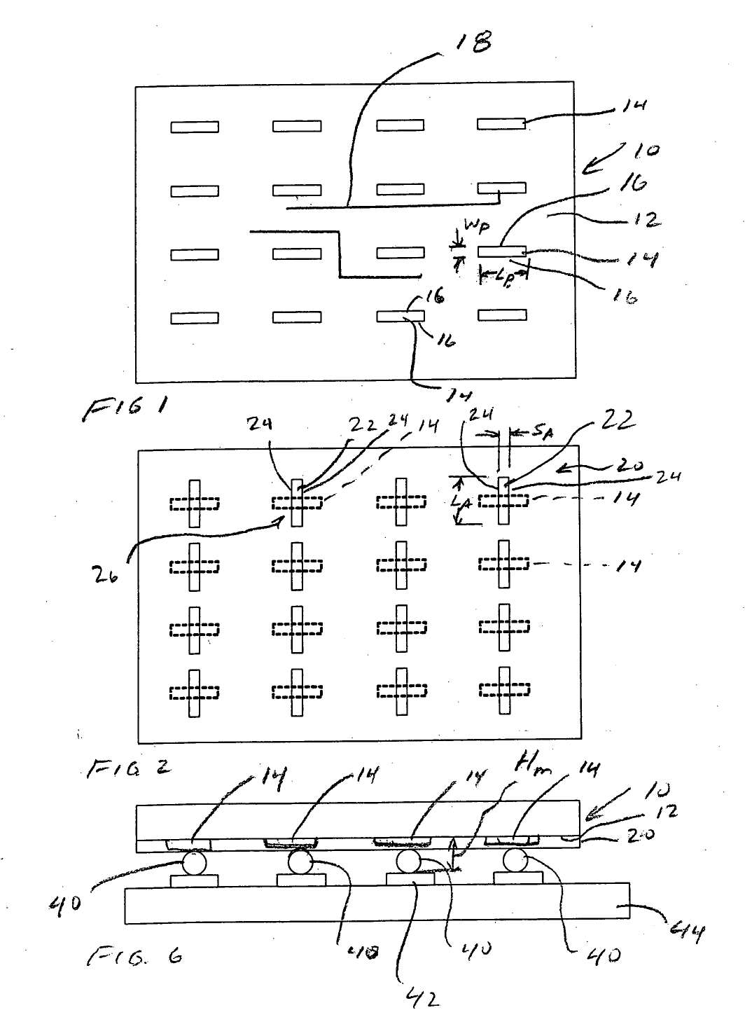

In the particular embodiment illustrated, body 10 has electrically conductive traces 18 extending along front surface 12 in the vicinity of at least some of the pads 14, so that the traces extend between the pads. At least some of the traces extending between the pads, and desirably the majority or all of such traces, extend in directions parallel to the lengthwise directions Lp of the pads disposed adjacent such traces. As will be apparent from FIG. 1, the relatively small widthwise dimensions of the pads leave more room for routing traces between the pads.

In a manufacturing process according to one embodiment of the invention, a solder mask layer 20 (FIG. 2) having apertures 22 therein is applied on the front face 12 of the body. The apertures 22 are also elongated; each aperture has a long dimension La and a short dimension Sa. Each aperture has a pair of opposed longitudinal edges 24 extending in the long dimension and spaced apart from one another in the short dimension. Each aperture 22 is aligned with one pad 14 so that the aperture and pad cooperatively define a unit 26. One such unit is illustrated on an enlarged scale in FIG. 3. The unit 26 depicted in FIG. 3 has the aperture in its desired, nominal position with respect to the pads. The aperture 22 in each unit extends across the pad 14 in the same unit. That is, the long dimension La of the aperture extends in the widthwise direction Wp of the pad in the same unit. The aperture 22 extends in the widthwise direction Wp of the pad beyond both long edges 16 of the pad. Conversely, the lengthwise direction Lp of the pad 14 of each unit extends in the short-dimension Sa of the aperture, and the pad extends beyond both longitudinal edges 24 of the aperture. Thus, each unit defines an effective, exposed wettable area 30 having dimensions equal to the width Wp of the pad 14 and the short dimension Sa of the aperture. Those portions of the pad outside of area 30 are covered by the solder mask and hence not wettable by the solder. Those portions of the aperture outside of area 30 overlie non-wettable surface 14 of the body.

The solder mask layer 20 can be applied by any conventional process as, for example, by laminating a layer having pre-formed apertures on the front surface of the body or, more typically, by applying a solid layer or curable liquid coating of a photoimageable masking material and then applying selectively exposing the layer or coating to light and curing and developing the exposed layer or coating so as to leave cured mask material in regions other than the apertures. Where the body is a semiconductor chip, the solder mask layer optionally may be applied while the chip is part of a wafer incorporating numerous semiconductor chips, and the chips may be severed after application of the solder mask layer. Likewise, where the body is a chip carrier or circuit panel, the process steps may be conducted while the body is in the form of a larger tape or sheet including numerous chip carriers or circuit panels, and these may be severed from one another after completion of the process steps. In the embodiment depicted, the solder mask layer 20 extends over the entire front surface 12 of the body, but this is not essential; the solder mask layer may be provided on less than the entire front surface.

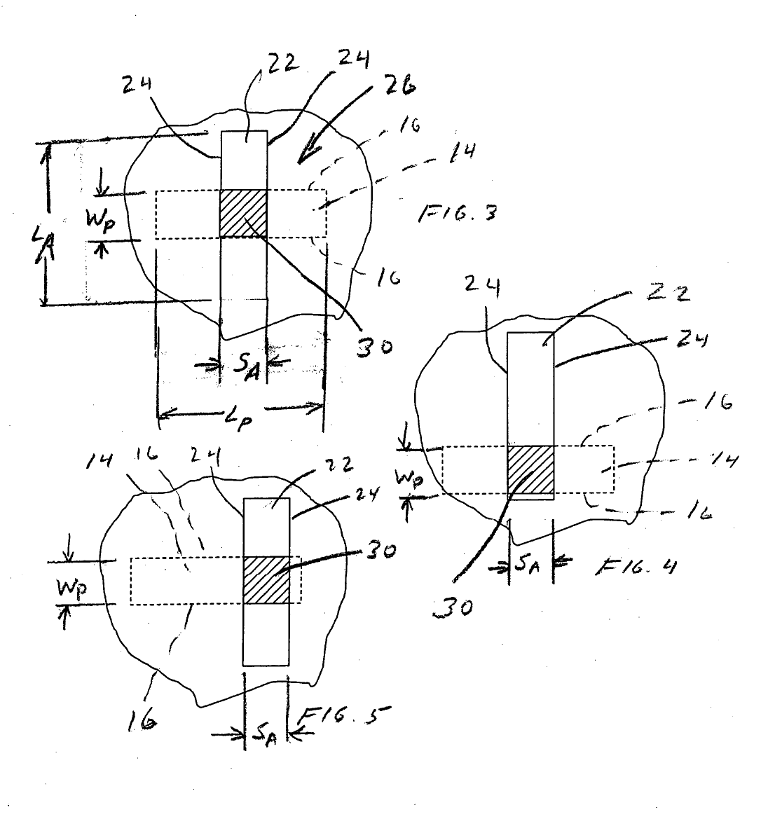

Regardless of the method used to apply the solder mask layer, there will normally be some misalignment between the apertures and the pads. For example, when a pattern-wise illumination process is used to form the apertures, the body may be displaced from its nominal position relative to the optical elements used to project the pattern of illumination which forms the apertures. Such misalignment does not substantially affect the size of the effective wettable areas. For example, in the unit depicted in FIG. 4, the aperture 22 is displaced from its nominal position relative to the pad 14 in the direction of the long dimension La of the aperture and the widthwise direction Wp of the pad. However, even with such displacement, the aperture still extends beyond both long edges 16 of the pad, and the pad extends beyond both long edges 22 of the aperture. Thus, in this condition as well, the effective wettable area of the unit still has dimensions equal to the widthwise dimension Wp of the pad and the short dimension Sa of the aperture.

In the unit depicted in FIG. 5, the aperture is displaced from its nominal position relative to the pad in the direction corresponding to the lengthwise direction Lp of the pad and the short dimension Sa of the aperture. Here again, however, the aperture 20 extends beyond both long edges 16 of the pad and the pad extends beyond both longitudinal edges 22 of the aperture. Thus, in this condition as well, the effective wettable area of the unit has dimensions Wp and Sa. Combinations of the displacements illustrated in FIGS. 4 and 5 yield the same result. Thus, the effective wetted areas of all of the units in the assembly, and of all of the units in a plurality of assemblies made by the same process, are substantially equal.

To provide the equal wettable areas as discussed above, the long dimension of the aperture La should exceed the pad width Wp by a difference (La−Wp) greater than or equal to twice the expected tolerance in positioning, and the pad length Lp should exceed the short dimension of the aperture Sa by a difference (Lp−Sa), which should also be greater than or equal to twice the expected tolerance in positioning. Thus, when the pad and aperture are at nominal position with respect to one another, the aperture extends beyond each edge of the pad by an amount at least equal to the positioning tolerance, and the pad extends beyond each edge of the aperture by an amount which is at least equal to the positioning tolerance.

The equal effective wettable areas 30 of the various units help to assure that solder masses formed by wetting the units with molten solder will have substantially constant shape and volume. For example, as seen in FIG. 6, solder masses 40 are formed on the effective wetted areas of several units. Because all of these solder masses are of equal volume and of substantially the same shape, they all have substantially equal height Hm above the front surface 12 of the body 10. In FIG. 6, the thickness of solder mask layer 20 is greatly exaggerated for clarity of illustration. In actual practice, this layer typically is about 10-20 μm thick or less. The equal height of the solder masses facilitates engagement of the solder masses with pads of a test fixture and with pads 42 of a substrate 44. In the condition illustrated in FIG. 6, the component including body 10, mask layer 20 and solder masses 40 has been placed with the front surface 12 of the body facing toward the front surface 46 of substrate 44, and the units have been aligned with the pads 42 of the substrate. In the next step of the process, solder masses 40 are engaged with pads 42 of the substrate and reflowed so as to bond the pads 14 to pads 42, thereby connecting body 10 to substrate 44.

Numerous variations and combinations of the features discussed above can be employed. For example, pads and a solder mask layer as discussed above can be provided on any type of microelectronic element as, for example on a circuit board or on a connection component which forms part of the packaging of a packaged semiconductor chip. Also, the directions of elongation of the pads need not be parallel to one another. Where the directions of elongation of the individual pads differ, the orientation of the individual apertures should also differ, so that each aperture extends across the associated pad as discussed above. Also, although the long dimension of the aperture in each pad/aperture unit desirably is exactly perpendicular to the lengthwise direction of the pad in such unit, this is not essential. The long direction of the aperture need merely be transverse to the lengthwise direction of the pad. Further, it is not essential to use rectangular pads and apertures as depicted in the drawings; other elongated shapes may be employed.

As these and other variations and combinations of the features discussed above can be utilized without departing from the invention as defined by the claims, the foregoing description of the preferred embodiments should be taken by way of illustration rather than by way of limitation of the invention as defined by the claims.

1. A component for making a soldered connection comprising:
(a) a body having a front surface and a plurality of elongated solder-wettable pads exposed at said front surface, each said pad having lengthwise and widthwise directions and pad length and pad width dimensions; and
(b) a solder mask layer overlying at least a part of said front surface, said mask layer defining a plurality of elongated apertures, each said aperture having long and short dimensions, at least some of said apertures extending across at least some of said pads so as to form a plurality of units, each unit including one of said pads and one of said apertures extending across the pad in such unit, the long dimension of the aperture in each such unit extending in the widthwise direction of the pad, the long dimension of the aperture being greater than the width of the pad so that the aperture extends beyond the pad on two opposite sides thereof, the pad length of the pad in each such unit being greater than the short dimension of the aperture in such unit so that the pad extends beyond the aperture on two opposite sides thereof, whereby each such unit has a wettable area having dimensions equal to the width of the pad and the short dimension of the aperture.

2. A component as claimed in claim 1 wherein the pad widths of all of said pads are substantially equal and the short dimensions of all of said apertures are substantially equal, whereby the dimensions of all of said wettable areas are substantially equal.

3. A component as claimed in claim 1 wherein the lengthwise directions of all of said pads are parallel to one another.

4. A component as claimed in claim 3 wherein said body has traces extending along said front surface between at least some of said pads, said traces extending predominantly in a direction parallel to the lengthwise directions of said pads.

5. A component as claimed in claim 1 further comprising masses of solder adhering to the wettable areas of said units.

6. A component as claimed in claim 1 wherein said body is a semiconductor chip.

7. A component as claimed in claim 1 wherein said body is a connection component.

8. A method of making a microelectronic assembly comprising placing a component as claimed in claim 1 over a substrate so that said units confront lands on said substrate, providing solder between said units and said lands, and solder bonding said wettable areas of said units to said lands.

9. A method as claimed in claim 8 wherein said step of providing solder includes providing solder on said wettable areas of said units before said placing step.

10. A method of making a microelectronic component comprising the steps of:
(a) providing a body having a front surface and elongated solder-wettable pads; and
(b) providing a solder mask over at least a portion of said front surface so that elongated apertures in said solder mask extend across said elongated pads to form units, the aperture extends of each unit extending beyond the pad of the unit on two opposite sides thereof, the pad of each unit extending beyond the aperture of the unit on two opposite sides thereof, whereby each unit has a wettable area with dimensions equal to the short dimension of the aperture and the widthwise dimension of the pad.

11. A method as claimed in claim 10 wherein said step of providing a solder mask includes selectively exposing the mask to light so as to form the apertures.

12. A method as claimed in claim 11 wherein said step of providing a solder mask includes forming the mask with said apertures and laminating said mask on said front surface of said body.
